(19) United States
(12) Patent Application Publication
(10) Pub. No.: US 2013/0095700 A1
(43) Pub. Date: Apr. 18, 2013

(54) LIGHT WEIGHT HARD NOSE PLUG WITH ABRASIVE RESISTANT FACE PLATE

(71) Applicants: PRESTON SHULTZ, Woodstock, CT (US); Kevin Crowl, Upper Jay, NY (US)

(72) Inventors: PRESTON SHULTZ, Woodstock, CT (US); Kevin Crowl, Upper Jay, NY (US)

(21) Appl. No.: 13/276,176

(22) Filed: Oct. 18, 2011

(51) Int. Cl. H01R 24/20; H01R 13/46

(52) U.S. Cl. 439/660; 439/892

(57) ABSTRACT

An electrical plug is provided for supplying electricity comprising a plug with two sections, a body section and a detachable faceplate section. The faceplate is compact and is fabricated using a hard flexible plastic which enables the faceplate to act as a cover to the plug and enhances the resistance of the plug to the wear and tear of its field uses. The faceplate can be secured onto the body of the plug without any stress cracking using screws despite the compact thickness of the faceplate.

### BACKGROUND OF THE INVENTION

1. Field of the Invention

This invention relates generally to an assembly for transferring electrical power and more particularly to a plug assembly having a hard nose that is abrasion resistant.

2. Description of Background

A sizable fraction of ignitions of structures, resulting in serious fires, are due to electrical distribution problems. Every year, these electrical fires account for many deaths and injuries, and millions of dollars in direct property damage. The cause of many electrical distribution problems can be attributed to faulty wirings, cords and plugs. The malfunctioning of these components often lead to overheating or sudden generation of sparks that can potentially cause fires and even explosions. The source of such malfunctions can be varied, stemming from arcing, short circuits, poor connections or sudden rupturing and shearing of cables caused by tensile forces.

An electric arc can be defined as formation of a channel of hot ionized plasma gas that is highly conductive. This causes an electrical breakdown, resulting in a flow of current between contacts separated by small gaps, even in instances where they are separated by insulative coating or a nonconductive media such as air. An unintended electric arc or alternatively arc flash, can be particularly detrimental to electric power transmission and distribution systems. In addition, an electrical arc can result in very high temperatures that melt most material and poses serious threats of injury. Devices which may cause arcing include switches, circuit breakers, relay contacts, fuses and cables, especially cables with poor terminations.

Short circuits are caused when there is a surge of current in an unintended part of a circuit or a network. When an abnormally low resistance connection is created between two nodes that are meant to be kept at different voltages, charges flow quickly along this different and unintentionally formed path. The sudden flow of excessive electric current leads to overheating of the device and the surrounding areas, potentially causing fires and explosions. Short circuits are most likely to occur between conductors of two different phases, such as that of voltage/power phases and neutral/ground phases. It is, however, possible for short circuits to arise between two conductors of the same phase.

A number of conditions can cause an unintentional short circuit. Some examples are structurally damaged or bent metal components like prongs and socket contacts, stalled motors, and jammed pumps/fans caused by debris. Short circuits can also be caused by worn insulations, such as on wires, cables and other electrical components. For example, a worn wire insulation in a battery cell can expose the underlying metal and create a path between positive and negative terminals. The ensuing low resistance across this connection then causes a large amount of energy to be dispersed quickly. The rapid buildup of associated heat can lead to fires/explosions that can release hydrogen gas and electrolytes and/or cause chemical exposures to acids or base fluids.

In the airline industry, electrical fires are a source of major concern not just in the air, but more importantly on the ground. Aircraft ground power assemblies are required to deliver ground power to aircrafts when parked or when in hangers undergoing inspection and repair. Faulty electrical distribution in these assemblies can lead to disastrous results. Proximity to large amounts of highly combustible jet fuel creates an excessive risk of damage and injury to nearby structures and individuals. In airports located close to densely populated areas, contamination issues and potential for complete infrastructural collapse further exacerbates this risk.

In recent years, electrical fires have been more frequently caused by faulty cables/plugs and worn insulations. Shearing and rupturing of cables can cause sparks and short circuits. In addition, misalignment of contacts caused by prolongued use, overheating or sudden forces experienced during engagement and disengagement of devices can also lead to electrical malfunctions. Consequently, minimizing the risk of electrical shorts and other related conditions caused by faulty cables and plugs is desired, especially when such components are utilized in assemblies that supply ground power to aircrafts.

### SUMMARY OF THE INVENTION

The shortcomings of the prior art are overcome and additional advantages are provided through the provision of an electrical plug for providing electricity comprising a plug housing having a body and a nose with a plurality of openings. The plurality of electrical contacts are disposed in the housing, some distance away from a proximal end of the nose openings. The nose being enabled to engage and disengage with a socket at said proximal end and establish electrical connections with the contacts; and the body enabled to receive a cable. The nose having a faceplate having a complementary geometry such that said faceplate is secured to said nose while enabling said openings to engage with said socket. The faceplate being fabricated such that it provides textual protection to said nose such that abrasive forces are reduced during engagement and disengagement of said plug nose with said socket.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view illustration of a hard nose plug connector as per one embodiment of the present invention;

FIG. 2 is an illustration of a faceplate as per one embodiment of the present invention;

FIG. 3 is a perspective view illustration of the faceplate of FIG. 2;

FIG. 4 is a side view illustration of the faceplate and the plug secured to one another as per one embodiment of the present invention;

FIG. 5 is a side view illustration of the plug as per the embodiment of FIG. 1;

FIG. 6 is a perspective view illustration of the plug and faceplate secured to one another;

FIG. 7 is a side view illustration of the plug and faceplate after being secured to one another as per one embodiment of the present invention;

FIG. 8 is another perspective illustration of the plug and faceplate combination after being secured to one another as per one embodiment of the present invention;

FIG. 9 and FIG. 10 are alternate view illustrations of the plug and the faceplate when not being secured to one another.

### DESCRIPTION OF THE INVENTION

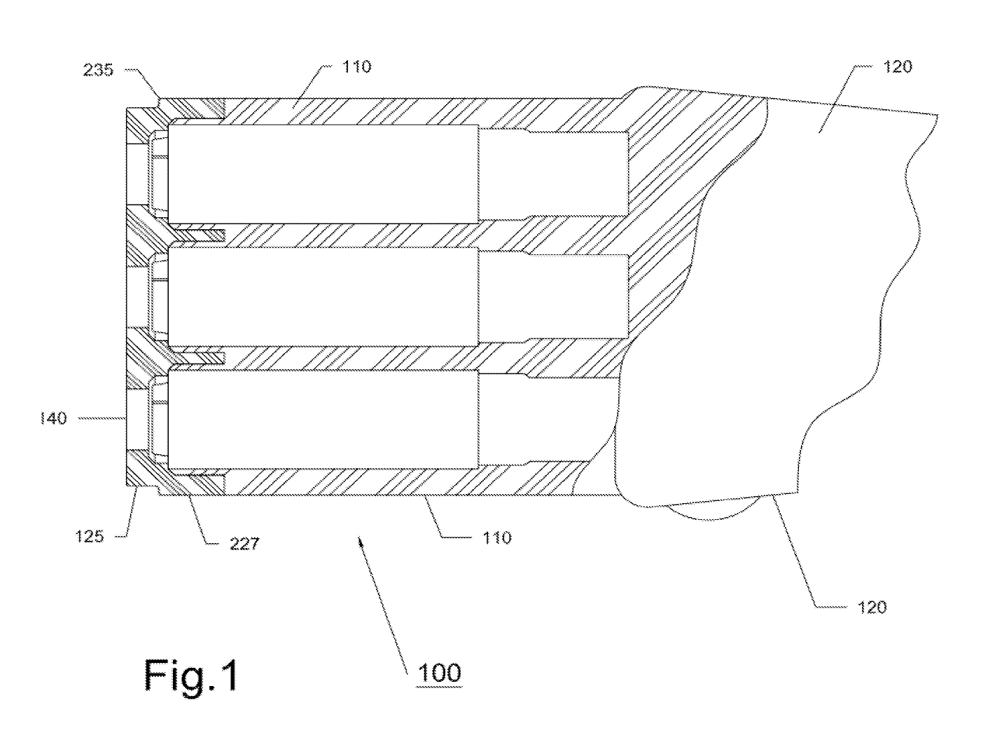

FIG. 1 is an illustration of an electrical plug 100 according to one embodiment of the present invention. The plug 100 has a housing 110 comprising of a nose 120 and a body 130. The body 130 is either enabled to be secured to a cable or alternatively receive the cable such that the cable is partially received inside the body, thus creating an electrical seal.

The nose 120 has openings 140 to enable electrical connection be made between electrical contacts in the plug 100 and an electrical socket. The number of openings 140 in the nose 120 correspond with the electrical contacts disposed in the plug as will be discussed later. The number, shape and location of the openings 140 can be selected according to the anticipated usage and industry standards as can be appreciated by those skilled in the art. For example, one preferred usage of the plug is for use with aircrafts. The placement and size and shape of the openings 140 in such a case will be in conformance with the sockets used in this industry. Furthermore, for example, if military aircraft is being used, design adjustments will be made at time of plug fabrication to ensure that the plug design is in conformance to those standards and requirements

In the exemplary embodiment as shown in FIG. 1, the electrical connection will be provided through a plurality of socket and pin arrangements as known to those skilled in the art. However, as discussed, other arrangements are also possible according to usage. In addition, as stated before, the size, shape and location of the openings and thus their corresponding contacts can be varied. This means that one or even a first set of openings, for example, may be of a first size and shape and be placed closely together while other openings may be of a second size and shape and be disposed further apart.

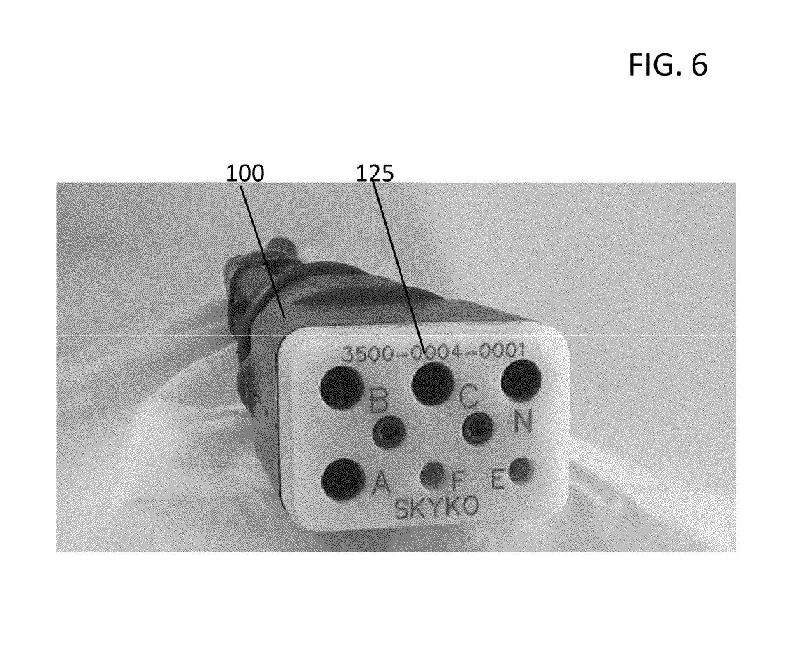

In a preferred embodiment as shown in FIG. 1, there is a plurality of socket pins. In FIG. 6, six socket pins are provided. The socket pins can be of uniform size and shape or be varied from one another. In one embodiment as shown, a plurality of socket pins has a first size and configuration while the remaining one have a different second size and configuration. In the example shown in the illustration of FIG. 1, six openings are shown that are not all of the same size.

As shown in FIG. 1, the nose 120 has a proximal and a distal end. The distal end is disposed on the body side while the proximal side will be mating or receiving the docket. The nose 120 comprises a faceplate 125 at its proximal end. The faceplate is designed so as to be complementary with the openings 140 such that a good electrical connection can be made. The faceplate is designed to reduce forces on the nose plate. In addition, the faceplate 125 increases abrasion resistance of the nose of the connector plug in areas exposed to tensile friction.

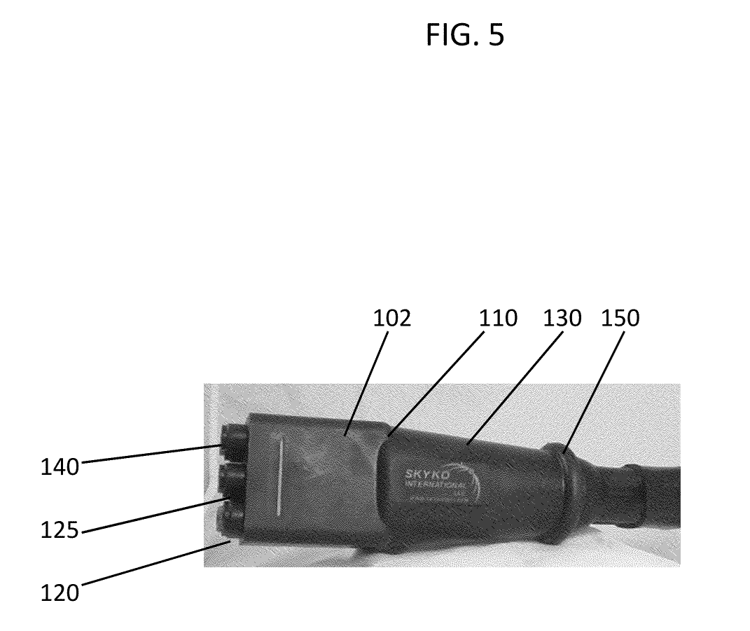

FIGS. 5, 9 and 10 also provide alternate views of the plug of FIG. 1 as described to help better show the details of the features discussed.

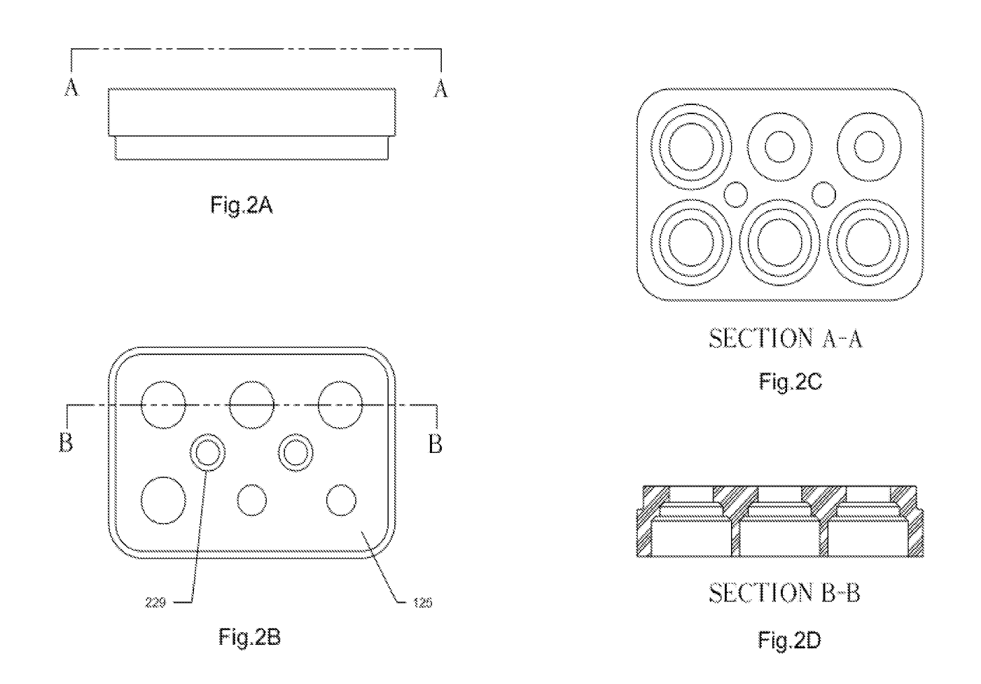

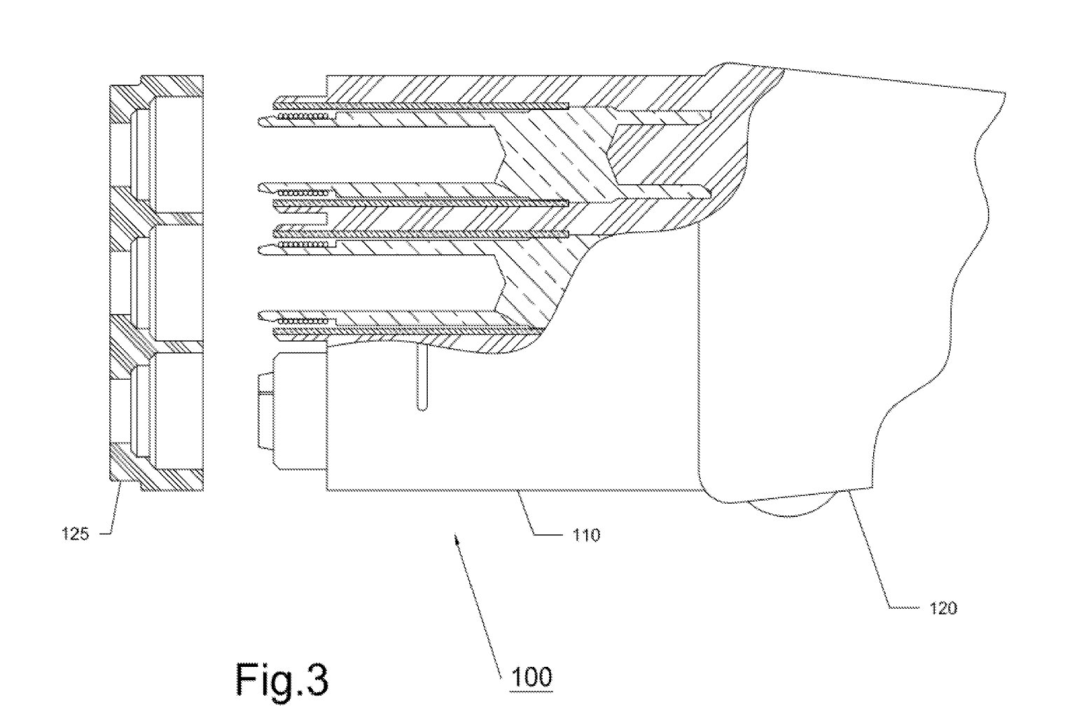

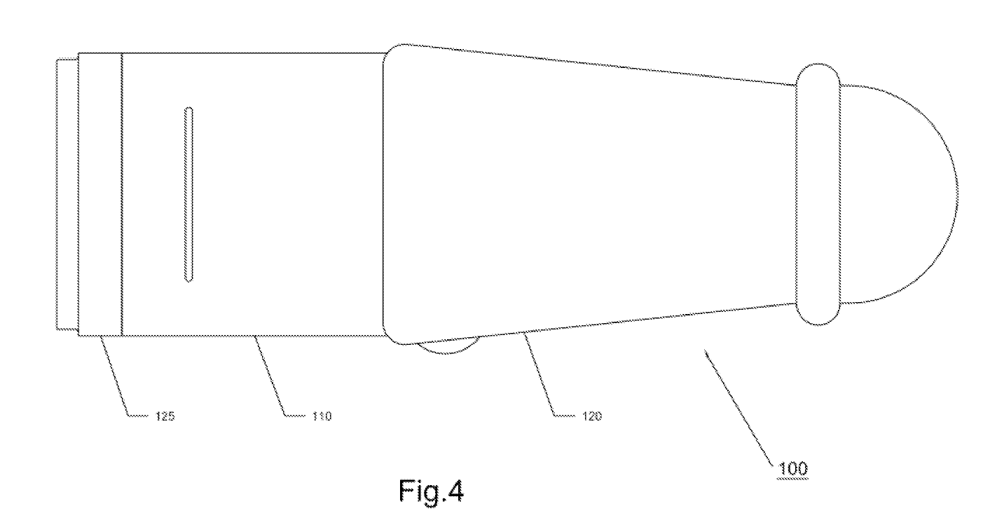

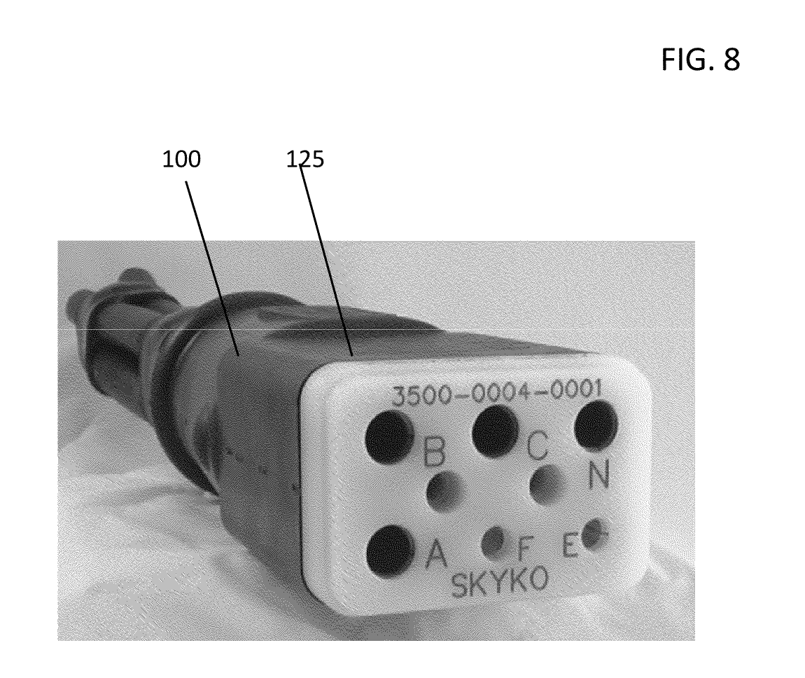

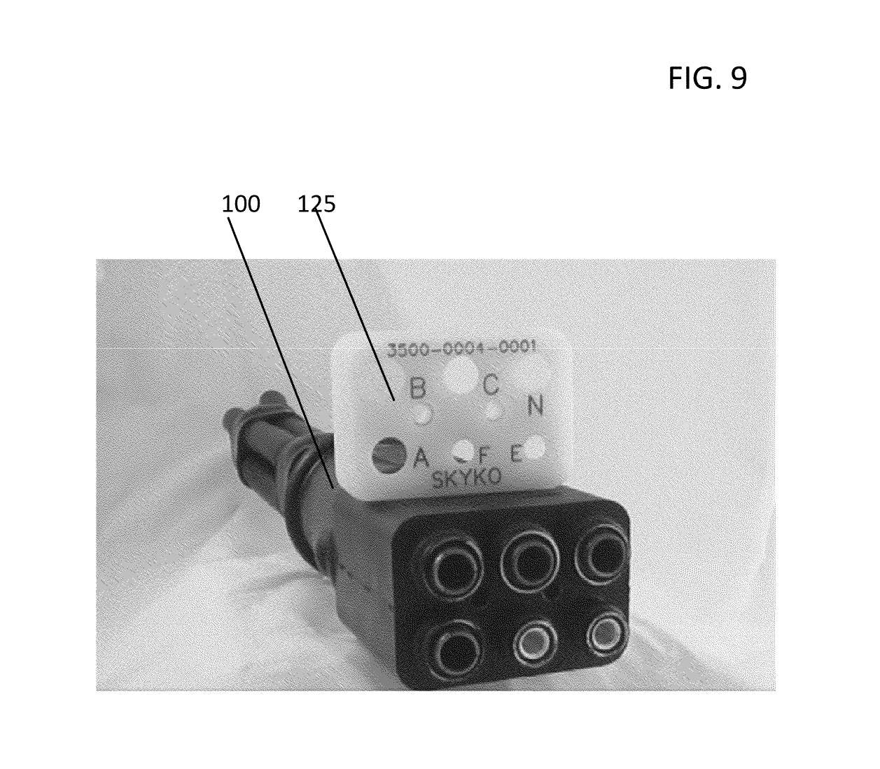

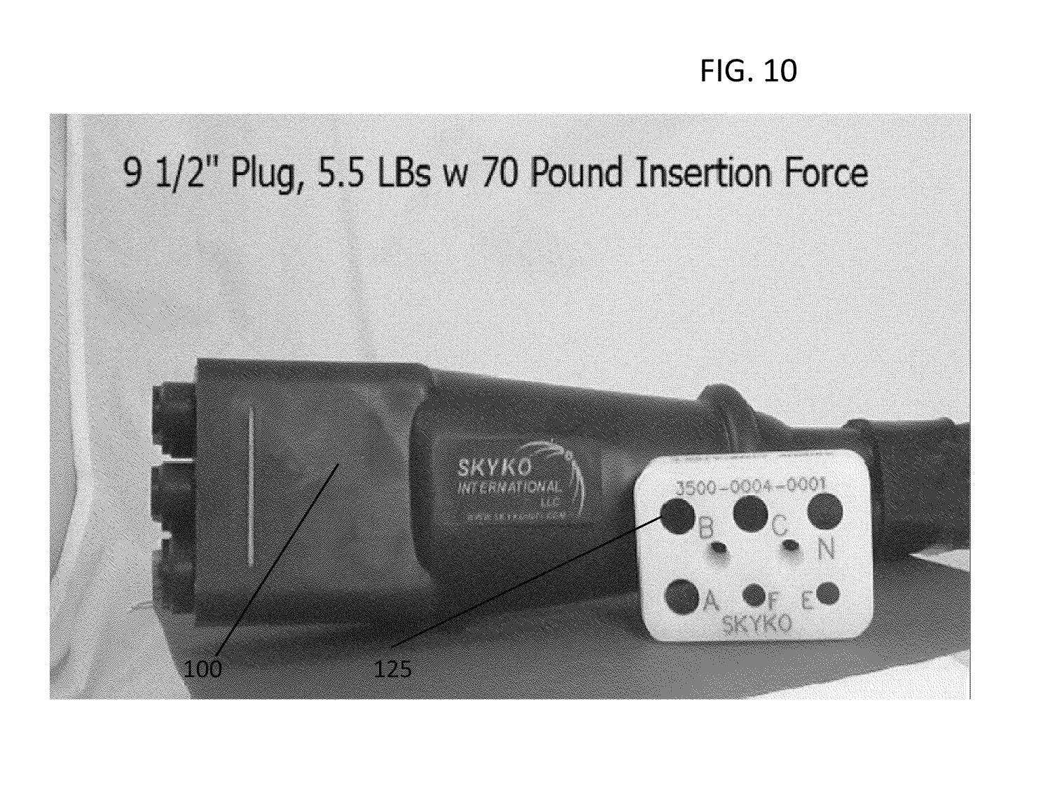

FIG. 2 and FIG. 3 are different views showing illustration of the faceplate 125 by itself. The faceplate can be secured to the nose 120 in a number of ways. The faceplate 125 can be an integral part of the nose 120 or be a separate unit as shown in FIG. 2. In such a case the faceplate will then be secured to the proximal end of the nose 120. In one embodiment, the faceplate 125 is secured to the body of the connector plug via fasteners. A variety of fastener types can be used in different quantities and shapes as can be appreciated by those skilled in the art. In one embodiment of the present invention, the connectors are secured to the body 130 using one or more bolts (not illustrated). In a preferred embodiment, where the faceplate 125 is secured to the body, it is secured to a portion of the body that is preferably fabricated of molded and even flexible rubber. In addition the faceplate 125 can have a complementary shape to the nose such that it can receive or be received by the nose 120 in a manner so as to provide a secure fit. For example, the faceplate can have lips 227 as shown in FIG. 4 that overextend the nose 120 to enable a secure grip. Many alternative embodiments are also available as known to those skilled in the art including but not limited to molding, fusing, use of adhesives and the like. When fasteners are used one or more openings and/or holes can be provided to enable attachment. In FIGS. 2 and 3, two holes 229 are provided by means of example. FIGS. 4 and 8 show the faceplate 125 when secured to the plug 100. FIGS. 9 and 10 show both the faceplate 125 and the plug 100 when not secured to one another and as two integral pieces.

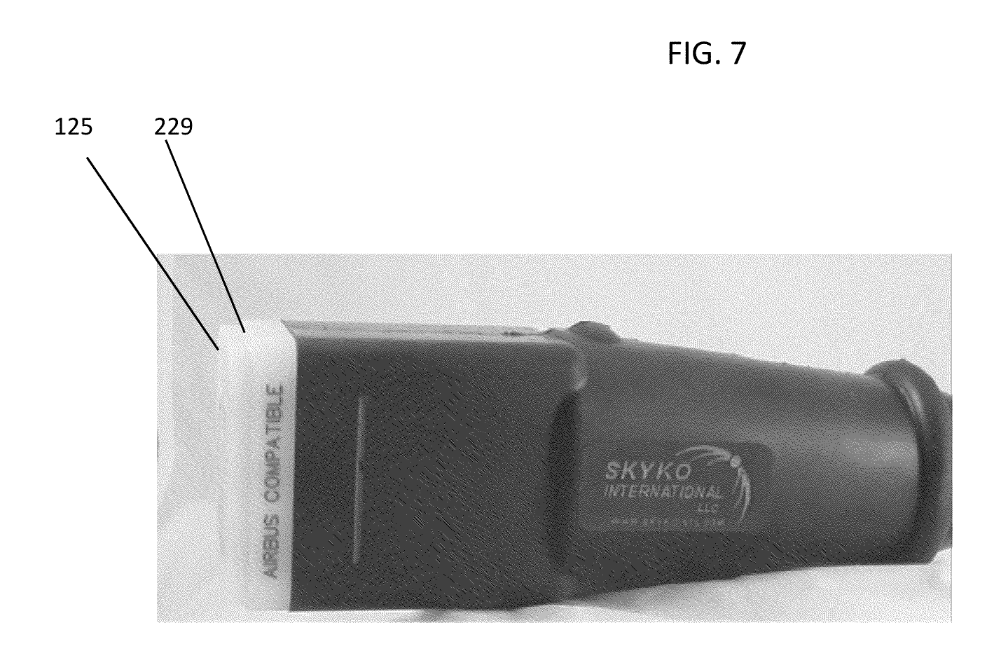

In a preferred embodiment, the faceplate 125 further includes a chamfered design on one or more sides. In one embodiment a chamfered edge 235 can be provided on one or all sides. The chamfered edge can be best viewed in the illustration of FIG. 7. This will enable better connectivity as well as a reduction in abrasive forces when engaging or disengaging the plug from the electric socket.

Protection of conductor plug noses is of particular concern when providing electricity to the aircraft. Conventional connectors are heavy, weighing close to hundred pounds in some instances. In addition, these conventional plugs are of such shape and configuration that their manipulation is extremely difficult both during transportation and handling during a service or maintenance call.

Furthermore, one of the greatest problems associated with providing electricity to often stationary (but not always) airplanes in airports is the problem of wear and tear in the nose of the conventional electrical plugs used. This wear and tear is caused by abrasive forces exerted on the plug especially during its engagement and disengagement from the socket.

Two particular design problems exacerbate this situation. For one, the body of most electrical connectors is fabricated by securing a plurality of individual pieces to one another. Because of the size and awkward dimensions of the cable and plug combination in these conventional plugs, transportation of the plugs is difficult as discussed. Consequently, often times the ground crewmembers drag the connectors on the ground and handle the connectors roughly. This exerts stress on different areas of the plug and cable connector. In addition the weight and configuration of the plug create tensile forces on the plug. Both the rough handling and the weight cause the body that is comprised of different pieces as well as the nose of the connector plug to become abraded and damaged. The continuous insertion and removal of the plug also creates additional abrasion exposes the nose to various stresses.

In most conventional plugs, electrical contacts are disposed in the nose section. Therefore, most manufacturer and designers of these plugs try to address this issue by enforcing the nose and/or even the body of the plug to minimize damage to the plug. Unfortunately, this effort only adds to the weight of the plug connector. The added weight will only exacerbate the situation discussed above and leads to more damage and abrasion during insertion, transportation and handling of the plug.

The combination of these conditions causes the nose and other pieces of the plug, especially rubber pieces, to wear away or get damaged quickly. Once one or more pieces are damaged, arcing and fires become more likely. This is especially as of concern when rubber pieces on the nose are damaged since the electrical contacts disposed in that area become exposed to the elements.

In the embodiment of FIG. 1, many of the shortcomings of the prior art are addressed. As discussed earlier, the electrical contacts (not illustrated) are disposed in the housing and some distance away from the proximal end of the nose due to the usage of the faceplate 125. In a preferred embodiment, the contacts are fabricated of copper or substantially of copper. The addition of the faceplate 125, further provides an additional layer of protection against damaging forces exerted on the conductive plug 100. Due to its special design features as discussed, the faceplate 125 provides protection without adding to the overall weight of the plug as it is fabricated out of light materials. In fact, using the faceplate 125 allows the overall weight of the cable and plug assembly to be substantially reduced. In other words, the plug 100 as illustrated including the hard nose 120 components and the faceplate 125 together allow for a much lighter design that is at the same time less susceptible to wear and tear.

In addition, to further increase the resistance of the plug to damaging forces, in one embodiment, the plug 100 in its entirety can be fabricated as single unit. In this embodiment, the plug 100 is fabricated of a unitary molded material, preferably a plastic. The fabrication of the plug out of a single unit, allows the overall plug to be shorter and carry less weight. Conventional plugs are made out of several pieces that then need to be fastened to one another. This requirement adds extra space between the two plugs for the pins or other fastening means to securely connect one section to another, which as stated before adds to the overall weight and length of the plug. In addition, because these conventional plugs are made out of a plurality of sections, they tend to be more affected by the tensile forces once the plug is engaged with a socket. This latter can pose a serious problem, since the operation of the electrical device can be disrupted due to these forces. Even a momentary lapse in supply of electricity to the device can affect the integrity of the device, cause long flight delays, and/or affect compromise the security of the device and the environment it operates in.

Furthermore, the design of the plug 100 as per one embodiment such as shown in FIG. 1, enables better manipulation of the cable and plug combination during transportation and maintenance/service calls. As illustrated in FIG. 1, in this embodiment, the housing 110 is comprised of two areas. A first area 102 is comprised of a different shape than a second area 104. In this embodiment, the first area 102 is comprised of a rectangular shape. The second area 104, in this embodiment is cylindrical shaped so that it can be more easily gripped. In one embodiment, the nose 120 can be identical to the first area 102 or include some parts of it, or alternatively extend beyond it. Similarly, the body 130 can encompass the entire second area 104, extend beyond it or only comprise a portion of it.

In one embodiment, proceeding axially, from the proximal end of the nose 120 (and the rectangular shaped first area 102), the plug can be disposed in an electrical socket so as to make a connection. In this embodiment, only the rectangular area (first area 102) will be disposed in the socket even partially in some instances. The cylindrical area will remain outside the socket area. This will provide additional protection to the electrical connections and make gripping of the plug easier during transport and service calls. In addition, as stated earlier, the cylindrical shape of the plug in conjunction with its light weight allows easy manipulability of the plug. This allows the plug and cable combination to be carried and not dragged or handled roughly.

In a preferred embodiment, as shown in FIG. 10, a 9.5 inches plug with a 5.5 lbs with 70 pounds of insertion force is provided. In one embodiment, the plug when inserted with faceplate is designed not to progress beyond a certain point to help control the extra forces of tension in engagement and disengagement of the plug.

It should be noted, that while the connector 100 is mainly designed to be inserted into the socket of an aircraft. It can also be used to facilitate electrical connection with other electrical outlets as can be appreciated by those skilled in the art.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An electrical plug for providing electrical connections comprising:
a plug having a housing;
said housing divided into two sections;
a body section and a detachable faceplate section;
said faceplate section being secured to said body section and having a plurality of openings allowing said faceplate to engage and to disengage with an electrical socket and establish electrical connections;
said faceplate being fabricated of a material enabling said faceplate to have a compact thickness and enabling said faceplate to have enhanced resistance to wear and tear;
said body section having openings which are aligned with said openings in said faceplate and said body section enabled to receive a cable.

2. The plug of claim 1, wherein said plug housing is fabricated of an integral unit.

3. The plug of claim 1, wherein said body section is comprised of a first rectangular area and a second cylindrical area, said rectangular area including at least said faceplate section and said cylindrical area at least partially encompassing said body section.

4. (canceled)

5. (canceled)

6. (canceled)

7. (canceled)

8. (canceled)

9. The plug of claim 1, wherein said faceplate is fabricated of flexible plastic.

10. The plug of claim 1, wherein said nose is fabricated of nonflexible molded rubber.

11. The plug of claim 1, wherein said faceplate has at least one chamfered edge.

12. The plug of claim 1, wherein said faceplate has a plurality of chamfered edges.

13. The plug of claim 1, wherein said faceplate is rectangular in shape having chamfered edges on each side.

14. The plug of claim 1, wherein said faceplate is secured to said body section.

15. The plug of claim 12, wherein said faceplate is secured to said body section by at least one fastener.

16. The plug of claim 14, wherein said faceplate is secured to said body section via a plurality of bolts and said faceplate is designed to receive said bolts thorough one or more openings.

17. The plug of claim 1, wherein said faceplate is fabricated as an integral unit with said body section.

18. The plug of claim 1, wherein said plurality of openings to receive said socket are of different sizes and shapes and said plurality of openings are disposed at different distances from one another.

19. (canceled)

20. An apparatus for providing power to an aircraft which is capable of a higher resistance to the wear and tear of field use, which comprises:
a faceplate securable to said body section of said plug used to provide power to an aircraft;
said faceplate having a complementary geometry to said body section of said plug;
said faceplate having a plurality of openings to enable said plug to engage with an electrical socket;
said faceplate having one or more openings for a fastener to secure said faceplate to said body section of said plug;
said faceplate having a plurality of chamfered edges on each side.

21. The plug of claim 1, wherein said faceplate can have a thickness of less than 0.8 inches.
